(19) United States
(12) Patent Application Publication
(10) Pub. No.: US 2026/0088367 A1
(43) Pub. Date: Mar. 26, 2026

(54) ENERGY STORAGE CELL AND METHOD OF MANUFACTURING SUCH AN ENERGY STORAGE CELL

(71) Applicant: VARTA Microbattery GmbH, Ellwangen Jagst (DE)

(72) Inventors: Stefan STOCK, Rainau-Dalkingen (DE); Martin ELMER, Ellwangen (DE)

(21) Appl. No.: 19/106,645

(22) PCT Filed: Aug. 28, 2023
(86) PCT No.: PCT/EP2023/073532

§ 371 Date: Feb. 26, 2025

(30) Foreign Application Priority Data
Sep. 1, 2022 (EP) 22193543.0

(51) Int. Cl. H01M 10/0587; H01M 4/75; H01M 10/04; H01M 50/107; H01M 50/119; H01M 50/184; H01M 50/186; H01M 50/342; H01M 50/533; H01M 50/536

(52) U.S. Cl. CPC H01M 10/0587; H01M 4/75; H01M 10/049; H01M 50/107; H01M 50/119; H01M 50/184; H01M 50/186; H01M 50/3425; H01M 50/533; H01M 50/536

(57) ABSTRACT

An energy storage cell includes an electrode-separator assembly comprising a ribbon-shaped anode, a ribbon-shaped cathode, and a separator. The anode and the cathode are formed and/or arranged within the electrode-separator assembly, which is formed as a cylindrical winding with a first terminal end face and a second terminal end face, such that a free edge strip of a cathode current collector or a free edge strip of an anode current collector protrudes from the first terminal end face. The energy storage cell further includes a housing closed in an airtight and liquid-tight manner and enclosing an interior space in which the electrode-separator assembly is arranged. The housing includes a metallic housing cup and a lid assembly. The lid assembly includes a metallic contact element. The free edge strip protruding from the first terminal end face is welded to the contact element of the lid assembly.

### CROSS REFERENCE TO RELATED APPLICATIONS

This application is a U.S. National Phase application under 35 U.S.C. § 371 of International Application No. PCT/EP2023/073532, filed on Aug. 28, 2023, and claims benefit to European Patent Application No. EP 22193543.0, filed on Sep. 1, 2022. The International Application was published in German on Mar. 7, 2024 as WO/2024/046982 under PCT Article 21(2).

### FIELD

The present disclosure relates to an energy storage cell and a method for manufacturing an energy storage cell.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions.

The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials that can be used for the positive electrode include lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

The composite electrodes are generally combined with one or more separators to form an electrode-separator assembly when manufacturing a lithium-ion cell. The electrodes and separators are often, but not necessarily, joined together under pressure, possibly by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a winding with the sequence positive electrode/separator/negative electrode. In the second case, a ribbon-shaped positive electrode and a ribbon-shaped negative electrode as well as at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required that are also capable of withstanding high currents during charging and discharging.

Cells for the applications mentioned are often formed as cylindrical round cells, for example with a form factor of 21×70 (diameter*height in mm). Cells of this type always comprise an assembly in the form of a winding. Modern lithium-ion cells of this form factor can already achieve an energy density of up to 270 Wh/kg.

WO 2017/215900 A1 describes cylindrical round cells in which the electrode-separator assembly and its electrodes are formed as a ribbon-shaped winding. The electrodes each have current collectors loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cell has a contact plate which rests on one end face of the winding and is connected to a longitudinal edge of one of the current collectors by welding. This makes it possible to electrically contact the current collector and thus also the associated electrode over its entire length. This significantly reduces the internal resistance within the described cell. As a result, the occurrence of large currents can be absorbed much better and heat can also be dissipated better from the winding.

### SUMMARY

In an embodiment, the present disclosure provides an energy storage cell. The energy storage cell includes an electrode-separator assembly comprising a ribbon-shaped anode, a ribbon-shaped cathode, and a separator with the sequence anode/separator/cathode. The anode includes a ribbon-shaped anode current collector with a first longitudinal edge and a second longitudinal edge parallel thereto. The ribbon-shaped anode current collector includes a main region loaded with a layer of a negative electrode material and a free edge strip extending along the first longitudinal edge and being not loaded with the negative electrode material. The cathode includes a ribbon-shaped cathode current collector with a first longitudinal edge and a second longitudinal edge parallel thereto. The ribbon-shaped cathode current collector includes a main region loaded with a layer of a positive electrode material and a free edge strip extending along the first longitudinal edge and being not loaded with the positive electrode material. The anode and the cathode are formed and/or arranged within the electrode-separator assembly, which is formed as a cylindrical winding with a first terminal end face, a second terminal end face, and a winding shell between the first and second terminal end faces, such that the free edge strip of the cathode current collector or the free edge strip of the anode current collector protrudes from the first terminal end face. The energy storage cell further includes a housing closed in an airtight and liquid-tight manner and enclosing an interior space in which the electrode-separator assembly is arranged. The housing includes a metallic housing cup with a terminal circular opening and a lid assembly with a circular edge that closes the circular opening. The lid assembly includes an annular seal of an electrically insulating material surrounding its circular edge, a metallic contact element, a metallic membrane electrically coupled to the contact element, and a metallic pole cap electrically coupled to the metallic membrane. The metallic membrane is configured to bulge or burst outwards from a defined excess pressure inside the housing. The housing cup includes, in axial sequence, a bottom, a central section and a closure section. The central section is formed as a cylinder and in the central section the winding shell of the electrode-separator assembly formed as a winding is in contact with the inside of the housing cup. In the closure section, the annular seal is in press contact with the lid assembly and the inside of the housing cup. The free edge strip protruding from the first terminal end face is welded to the contact element of the lid assembly.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1. is a cross-sectional view of an embodiment of an energy storage cell according to an embodiment;

FIG. 2 is a cross-sectional detailed view of an embodiment of an energy storage cell according to an embodiment;

FIG. 3 illustrates an embodiment of an energy storage cell in a cross-sectional detail view with a laser beam directed at a weld spot between the membrane and the contact element through an opening in pole cap; and

FIG. 4 illustrates an electrode-separator assembly, which is part of an energy storage cell according to an embodiment, and its components.

### DETAILED DESCRIPTION

The present disclosure provides for further increasing energy density of energy storage cells, for example, energy storage cells of the type described in WO 2017/215900 A1.

According to an embodiment, an energy storage cell has the immediately following features a. to 1:
a. The cell comprises an electrode-separator assembly with the sequence anode/separator/cathode.
b. The anode of the electrode-separator assembly is ribbon-shaped and comprises a ribbon-shaped anode current collector which has a first longitudinal edge and a second longitudinal edge parallel thereto.
c. The ribbon-shaped anode current collector comprises a main region loaded with a layer of a negative electrode material and a free edge strip extending along its first longitudinal edge which is not loaded with the negative electrode material.
d. The cathode of the electrode-separator assembly is ribbon-shaped and comprises a ribbon-shaped cathode current collector which has a first longitudinal edge and a second longitudinal edge parallel thereto.
e. The ribbon-shaped cathode current collector comprises a main region loaded with a layer of a positive electrode material and a free edge strip extending along its first longitudinal edge which is not loaded with the positive electrode material.
f. The electrode-separator assembly is in the form of a cylindrical winding with a first terminal end face and a second terminal end face and a winding shell between them and comprises the anode and the cathode in spirally wound form.
g. The ribbon-shaped electrodes are formed and/or arranged within the electrode-separator assembly, which is formed as a winding, in such a way that the free edge strip of the anode current collector or the free edge strip of the cathode current collector protrudes from the first terminal end face.
h. The cell comprises an airtight and liquid-tight housing which encloses an interior space in which the electrode-separator assembly is arranged and which has a metallic housing cup with a terminal circular opening and a lid assembly with a circular edge which closes the circular opening.
i. The lid assembly comprises an annular seal of an electrically insulating material surrounding its circular edge.
j. The housing cup comprises, in axial sequence, a bottom, a central section and a closure section, wherein the central section is formed as a cylinder and in the central section the winding shell of the electrode-separator assembly formed as a winding is in contact with the inside of the housing cup, and in the closure section, the annular seal is in press contact with the lid assembly and the inside of the housing cup.
k. The lid assembly comprises, from the inside to the outside, a metallic contact element, a metallic membrane which is electrically coupled to the metallic contact element and which bulges or bursts outwards from a defined overpressure inside the housing, and a metallic pole cap which is electrically coupled to the metallic membrane.

The energy storage cell is characterized in that
l. the free edge strip protruding from the first terminal end face of the electrode-separator assembly is welded to the contact element of the lid assembly.

The free edge strip protruding from the first terminal end face can be the free edge strip of the cathode current collector or the free edge strip of the anode current collector. Preferably, it is the free edge strip of the cathode current collector.

In contrast to WO 2017/215900 A1, the energy storage cell has a contact element that is part of a lid assembly. Accordingly, no separate electrical conductor is required between the lid and the contact element. The energy storage cell is therefore easy to manufacture. The absence of the separate conductor also means that the internal resistance of the energy storage cell can be reduced and that more usable volume is available in the housing, which means that more active material can be introduced into the housing to increase the energy density.

### Connecting One of the Electrodes to the Housing Cup

While one of the electrodes of the energy storage element is electrically coupled to the lid assembly via the free edge strip protruding from the first end face, the other of the electrodes is preferably electrically coupled to the housing cup. Accordingly, the energy storage element is preferably characterized by at least one of the following features immediately below:
a. The ribbon-shaped electrodes are formed as and/or arranged within the electrode-separator assembly, which is formed as a winding, in such a way that one of the free edge strips of the anode current collector and cathode current collector protrudes from the first terminal end face and the other of the free edge strips protrudes from the second terminal end face of the electrode-separator assembly.
b. The other of the free edge strips protruding from the second terminal end face of the electrode-separator assembly is electrically coupled to the bottom of the housing cup.

Here too, the free edge strip protruding from the first terminal end face is preferably the free edge strip of the cathode current collector. Accordingly, the edge strip protruding from the second terminal end face is preferably the free edge strip of the anode current collector.

The free edge strip protruding from the second terminal end face is preferably welded to the bottom of the housing cup.

Alternatively, the edge strip can also be electrically coupled to the bottom of the housing cup via a separate electrical conductor, for example a plate-shaped conductor. This separate electrical conductor can, for example, consist of nickel or copper or titanium or a nickel or copper or titanium alloy or stainless steel, for example of type 1.4303 or 1.4404 or of type SUS304, or of nickel-plated copper, in particular if the edge strip protruding from the second terminal end face is the free edge strip of the anode current collector.

### Preferred Structure of the Lid Assembly

The lid assembly is generally applied in pre-assembled form. In preferred embodiments, it is characterized by at least one of the features a. to f. immediately below:
a. The membrane is in direct contact with the contact element and is connected to it by welding.
b. The membrane has a circular shape and thus has a circular edge.
c. The contact element has a circular shape and thus has a circular edge.
d. The contact element is welded to the center of the membrane.
e. The contact element and the membrane have approximately the same diameter.
f. The membrane and the contact element are in electrical contact with each other exclusively via a welding area in the center of the membrane.

It is preferred that the immediately preceding features a. and b. and d. and f. are realized in combination. Preferably, all six immediately preceding features a. to f. are realized in combination.

Preferably, the membrane is in direct contact with the pole cap. In preferred embodiments, the membrane is connected to the pole cap by welding.

Preferably, the pole cap closes off the lid assembly on the outside.

In further preferred embodiments, the lid assembly is characterized by at least one of the features a. to c. immediately below:
a. The annular seal encloses the circular edge of the metal contact element.
b. The annular seal encloses the circular edge of the metallic membrane.
c. The annular seal separates the circular edge of the metallic membrane from the circular edge of the metallic contact element.

It is preferred that the immediately preceding features a. and b. and c. are realized in combination.

In preferred embodiments of the energy storage cell, the annular seal has several functions. Firstly, it electrically separates the lid assembly from the metallic housing cup and seals the housing at the same time. Secondly, it electrically separates the metallic contact element from the metallic membrane. For this purpose, it can have an F- or E-shaped cross-section, for example, as will be explained with reference to the drawings.

### Preferred Embodiment of the Free Edge Strip Protruding from the First Terminal End Face

Preferably, the energy storage cell is characterized by at least one of the features a. to c. immediately below:
a. The central section and the closure section are separated from each other by a radial indentation that circumferentially surrounds the outside of the housing cup in an annular shape.
b. The free edge strip protruding from the first terminal end face is wider than the distance d between the central section and the closure section, so that the edge strip bridges the distance d and is in direct contact with the contact element.
c. The distance d is defined by an upper edge and a lower edge of the indentation of the housing cup.

It is preferred that the immediately preceding features a. and b., preferably the immediately preceding features a. to c., are realized in combination.

Preferably, the energy storage cell is characterized by at least one of the features a. and b. immediately below:
a. The housing cup has an identical maximum outer diameter in the central section and the closure section.
b. In the region of the indentation, the outer diameter of the housing cup is reduced by 4 to 20 times the wall thickness of the housing cup in this region.

It is preferred that the immediately preceding features a. and b. are realized in combination.

In accordance with the above embodiments, the housing cup comprises an indentation section between the central section and the closure section, in which, in the axial direction, the diameter of the housing cup decreases from a maximum value to a minimum and then increases again to the maximum value.

Preferably, the energy storage cell is characterized by at least one of the features a. and b. immediately below:
a. The free edge strip protruding from the first terminal end face of the electrode-separator assembly is pressed inwards towards the center of the housing cup in the region of the indentation of the housing cup.
b. In the region of the indentation, an electrically insulating material is arranged between the inside of the housing cup and the free edge strip, which electrically insulates the free edge strip from the electrical potential of the housing cup.

It is preferred that the immediately preceding features a. and b. are realized in combination.

### Preferred Housing Shape

The energy storage cell is preferably a cylindrical round cell. Cylindrical round cells are known to have a cylindrical housing with a generally circular bottom.

The housing cup of the energy storage cell is usually formed by deep drawing. However, it is also possible to form the cup by welding a bottom into a tubular half-part.

Preferably, the height of the energy storage cell, which is formed as a cylindrical round cell, is in a range from 50 mm to 150 mm. Its diameter is preferably in a range from 15 mm to 60 mm. Cylindrical round cells with these form factors are suitable for supplying power to electric drives in motor vehicles.

As explained above, in a cell, the winding shell of the electrode-separator assembly formed as a winding is in contact with the inside of the housing cup in the central section. Preferably, it is in direct contact with the inside of the housing cup. In some embodiments, it may be provided to electrically insulate the inside, for example by means of a film. In this case, the winding shell of the electrode-separator assembly is in contact with or rests against the inside of the housing cup lined with the foil.

Preferably, the housing cup has an opening edge in the closure section that defines the circular opening, which is bent radially inwards over the edge of the lid assembly enclosed by the seal and which positively fixes the lid assembly including the seal in the circular opening of the housing cup.

Preferably, the annular seal is compressed in the closure section. It is preferably pressed against the edge of the lid assembly from the inside of the housing cup.

### Preferred Material Properties of Current Collectors, Housing Cup and Lid Assembly

The current collectors of the energy storage cell have the function of electrically contacting electrochemically active components contained in the respective electrode material over as large an area as possible. Preferably, the current collectors consist of a metal or are at least metallized on the surface.

In the case of a lithium-ion cell formed as an energy storage cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Stainless steel can also be considered, for example type 1.4303 or 1.4404 or type SUS304.

In the case of a lithium-ion cell formed as an energy storage cell, aluminum or other electrically conductive materials, including aluminum alloys, are suitable as the metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5 %.

Preferably, the anode current collector and/or the cathode current collector are each a ribbon-shaped metal foil with a thickness in a range from 4 μm to 30 μm.

In addition to films, however, other ribbon-shaped substrates such as metallic or metallized nonwovens or open-pored metallic foams or expanded metals can also be used as current collectors.

The current collectors are preferably loaded with the respective electrode material on both sides.

The housing cup preferably consists of aluminum, an aluminum alloy or a steel sheet, for example a nickel-plated steel sheet. Suitable aluminum alloys for the housing cup are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5 %.

The nature of the metallic components of the lid assembly often depends on whether the free edge strip protruding from the first terminal end face is the free edge strip of the cathode current collector or the free edge strip of the anode current collector.

If the free edge strip protruding from the first terminal end face is the free edge strip of the cathode current collector, it is preferred that the metallic contact element and preferably also the metallic membrane are made of the same or chemically similar material as the cathode current collector, i.e. in particular of aluminum or an aluminum alloy.

If the free edge strip protruding from the first terminal end face is the free edge strip of the anode current collector, it is preferable that the metallic contact element and preferably also the metallic membrane are made of the same or chemically similar material as the anode current collector, i.e. in particular of copper or nickel or a copper or nickel alloy or stainless steel.

The pole cover consists of nickel-plated steel or aluminum or an aluminum alloy, for example.

The annular seal preferably consists of an electrically insulating plastic material that has a melting point >200° C., preferably >300° C. The plastic material is a polyether ether ketone (PEEK), a polyimide (PI), a polyphenylene sulphide (PPS) or a polytetrafluoroethylene (PTFE).

### Electrodes and Electrode Materials

In a preferred embodiment, the energy storage cell is a lithium-ion cell.

Basically, all electrode materials known for secondary lithium-ion cells can be used for the electrodes of the energy storage cell.

Carbon-based particles such as graphitic carbon or non-graphitic carbon materials capable of intercalating lithium, preferably also in particle form, can be used as active materials in the anodes. Alternatively or additionally, lithium titanate (Li₄Ti₅O₁₂) or a derivative thereof can also be contained in the anode, preferably also in particle form. Furthermore, the anode can contain as active material at least one material from the group comprising silicon, aluminum, tin, antimony or a compound or alloy of these materials that can reversibly intercalate and redeposit lithium, for example silicon oxide (in particular SiOₓ with 0<x<2), optionally in combination with carbon-based active materials. Tin, aluminum, antimony and silicon can form intermetallic phases with lithium. The capacity for the receptable of lithium exceeds that of graphite or comparable materials many times over, especially in the case of silicon. Mixtures of silicon and carbon-based storage materials are often used. Thin anodes made of metallic lithium are also suitable.

Suitable active materials for the cathodes include lithium metal oxide compounds and lithium metal phosphate compounds such as LiCoO₂ and LiFePO₄. Lithium nickel manganese cobalt oxide (NMC) with the chemical formula LiNiₓMn_{y}Co_{z}O₂ (where x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with adjacent particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

### Preferred Material Embodiments of Electrolyte and Separator

The energy storage cell preferably comprises a liquid electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

Like the electrodes, the separator of an electrode-separator assembly of the energy storage cell is preferably formed as a ribbon-shaped separator. Alternatively, the electrode-separator assembly of the energy storage cell comprises more than one ribbon-shaped separator. For example, it may be preferred that the ribbon-shaped anode or the ribbon-shaped cathode is arranged between two ribbon-shaped separators.

The separator is preferably formed from an electrically insulating plastic film. It preferably has pores so that it can be penetrated by the liquid electrolyte. The plastic film can consist of a polyolefin or a polyether ketone, for example. Nonwovens and fabrics made of plastic materials or other electrically insulating fabrics can also be used as separators. Separators with a thickness in a range from 5 μm to 50 μm are preferred.

However, it is also possible for the ribbon-shaped separator to be a separator made of a solid-state electrolyte that has an intrinsic ionic conductivity and does not need to be impregnated with a liquid electrolyte. The solid-state electrolyte can, for example, be a polymer solid-state electrolyte based on a polymer-conducting salt complex, which is present in a single phase without any liquid component. The polymer matrix of a solid-state polymer electrolyte can be polyacrylic acid (PAA), polyethylene glycol (PEG) or polymethyl methacrylate (PMMA). Lithium conductive salts such as lithium bis-(trifluoromethane)sulfonylimide (LiTFSI), lithium hexafluorophosphate (LiPF₆) and lithium tetrafluoroborate (LiBF₄) can be present in these.

### Preferred Shapes Aad Dimensions of Electrodes and Separator

The anode current collector, the cathode current collector and the separator or separators of the cell preferably each have the following dimensions:
A length in a range from 0.5 m to 25 m,
A width in a range from 40 mm to 145 mm.

In the electrode-separator assembly formed as a winding, the ribbon-shaped anode, the ribbon-shaped cathode and the ribbon-shaped separator or separators are preferably wound in a spiral. To produce the electrode-separator assembly, the ribbon-shaped electrodes are preferably fed to a winding device together with the ribbon-shaped separator(s) and are preferably wound up spirally around a winding axis in the winding device. In some embodiments, the electrodes and the separator are wound onto a cylindrical or hollow-cylindrical winding core for this purpose, which rests on a winding mandrel and remains in the winding after winding.

The winding shell can be formed by a plastic film or an adhesive tape, for example. It is also possible for the winding shell to be formed by one or more separator windings.

It is preferred that the longitudinal edges of the separator or separators form the end faces of the electrode-separator assembly formed as a winding.

It is further preferred that the free edge strip of the anode current collector or the cathode current collector protruding from the first terminal end face of the electrode-separator assembly has a maximum protrusion in a range from 10 mm to 15 mm, preferably from 5 mm to 15 mm, more preferably from 5 mm to 10 mm, more preferably from 3 mm to 10 mm, preferably from 3 mm to 8 mm. This protrusion corresponds approximately to the width of the edge strip and the distance d between the central section and the closure section.

It is further preferred that the free edge strip of the anode current collector or the cathode current collector protruding from the second terminal end face of the electrode-separator assembly has a maximum protrusion in a range from 1 mm to 5 mm.

Preferably, the ribbon-shaped anode and the ribbon-shaped cathode are offset from each other within the electrode-separator assembly to ensure that the free edge strip of the anode current collector protrudes from one of the terminal end faces and the free edge strip of the cathode current collector protrudes from the other of the terminal end faces.

### Preferred Nominal Capacity of the Energy Storage Cell

The nominal capacity of a lithium-ion-based energy storage cell, which is formed as a cylindrical round cell, is preferably up to 15000 mAh. With the form factor of 21×70, the energy storage cell in an embodiment as a lithium-ion cell preferably has a nominal capacity in a range from 1500 mAh to 7000 mAh, preferably in a range from 3000 to 5500 mAh. With the form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturers'information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### Preferred Embodiment of the Contact Element

Covering the end faces of the electrode-separator assembly as extensively as possible and thus ensuring good connection of the current collectors is important for the current carrying capacity and thermal management of the energy storage cell. The larger the cover, the easier it is to contact the longitudinal edge of the respective current collector over its entire length. Heat generated in the electrode-separator assembly during charging or discharging can thus be easily dissipated via the contact element or the bottom of the housing cup.

Preferably, the energy storage cell is characterized by at least one of the features a. to h. immediately below:
a. The longitudinal edge along which the free edge strip protruding from the first terminal end face of the electrode-separator assembly extends forms a surface on which the contact element lies flat or into which the contact element is pressed.
b. The contact element is dimensioned such that it covers at least 40 %, preferably at least 60 %, preferably at least 80 % of the first terminal end face.
c. The contact element is a disk or a polygonal plate.
d. The contact element has at least one aperture, in particular at least one hole and/or at least one slot.
e. The contact element has a preferably uniform thickness in a range from 50 μm to 600 μm, preferably in a range from 150 μm to 350 μm.
f. The contact element has two opposing flat sides and extends essentially in only one dimension.
g. The contact element has at least one bead which appears on one flat side of the contact element as an elongate depression and on the opposite flat side as an elongate elevation, the contact element being pressed into the surface formed by the longitudinal edge with the flat side which bears the elongate elevation.
h. The contact element is welded to the longitudinal edge of the respective current collector in the region of the bead, in particular via one or more weld seams arranged in the bead.

It is preferred that the immediately preceding features a. to d. are realized in combination with one another. It is preferred that all features a. to h. are realized in combination with each other.

In some embodiments, it has proven advantageous to subject the longitudinal edge of the current collector protruding from the first end face to a pretreatment before the contact element is fitted. In particular, at least one depression can be folded into the longitudinal edge, which corresponds to the aforementioned at least one bead or the elongated elevation on the flat side of the contact element facing the first terminal end face.

The longitudinal edge of the current collector may also have been subjected to directional forming by pre-treatment. For example, it can be bent in a defined direction.

The at least one aperture in the contact element can be useful, for example, in order to be able to soak the electrode-separator assembly with an electrolyte. Furthermore, pressure generated in the interior space of the cell can act on the membrane through the aperture.

### Preferred Embodiment of the Pole Cap

Preferably, the energy storage cell is characterized by the immediately following feature a:
a. One or more openings are formed in the center and/or at the edge of the pole cap.

### Manufacturing Process

The method is used for manufacturing an energy storage cell comprising an airtight and liquid-tight sealed housing which encloses an interior space in which an electrode-separator assembly is arranged as described above, wherein the housing comprises a metallic housing cup with a terminal circular opening and a lid assembly with a circular edge which closes the circular opening. Reference is made to the above with respect to preferred features of the housing and lid assembly.

In preferred embodiments, the method is used to manufacture the energy storage cell described above.

The method is characterized by the immediately following steps a. to e:
a. There are provided a housing cup having a circular opening of circular shape and an electrode-separator assembly having a first end face and a second end face as defined in claim 1.
b. The electrode-separator assembly is inserted, second end face first, through the circular opening of the housing cup into the housing cup.
c. Before or after step b., a metallic contact element, in particular the contact element described above, is arranged on the first end face and fixed by welding.
d. To form the lid assembly, before or after step b., a membrane and a pole cap, in particular the membrane and pole cap described above, are placed on the contact element one after the other or as a pre-assembled assembly.
e. Before or after step b., but in any case after step d., a weld between the membrane and the contact element is formed.

Preferably before step d., but if necessary also after step d., electrolyte is dosed into the housing cup.

It is preferred that the housing is closed in a step f., forming the radial indentation described above in connection with the energy storage cell.

In principle, step e. can also be carried out after the closure in step f. However, step e. is preferably carried out before step f.

The housing is preferably closed by radially bending the edge of the opening defining the circular opening over the edge of the lid assembly enclosed by the seal, so that the lid assembly including the seal is positively fixed in the circular opening of the housing cup.

The radial indentation is preferably made in order to be able to exert axial pressure on the cell housing from above when the opening edge is bent over.

In further preferred embodiments, the radial indentation is formed as described in FIG. 8 A-C of EP 3916877 A1.

In preferred embodiments, to form the lid assembly, before or after step b., a membrane, an annular seal and a pole cap, in particular the membrane, seal and pole cap described above in connection with the cell, are arranged on the contact element one after the other or as a pre-assembled assembly.

A current collector protruding from the second end face of the electrode-separator assembly can be fixed to the bottom of the housing cup, for example by welding through the bottom.

In preferred embodiments, a height calibration of the cell to be produced is carried out in a further step g. This step can be carried out in particular as part of the closure process (step f.) or immediately after the closure process. In this context, the protrusion of the free edge strip of the anode current collector or the cathode current collector protruding from the first terminal end face of the electrode-separator assembly is important, as it can be deformed by axial pressure. For example, after step f., the height of the cell can be calibrated by applying axial pressure to its cover side. This can lead to compression of the protrusion. This is possible in particular if the electrically insulating material described above electrically insulates the protrusion from the electrical potential of the housing cup in the region of the indentation (see also claim 6, feature b.).

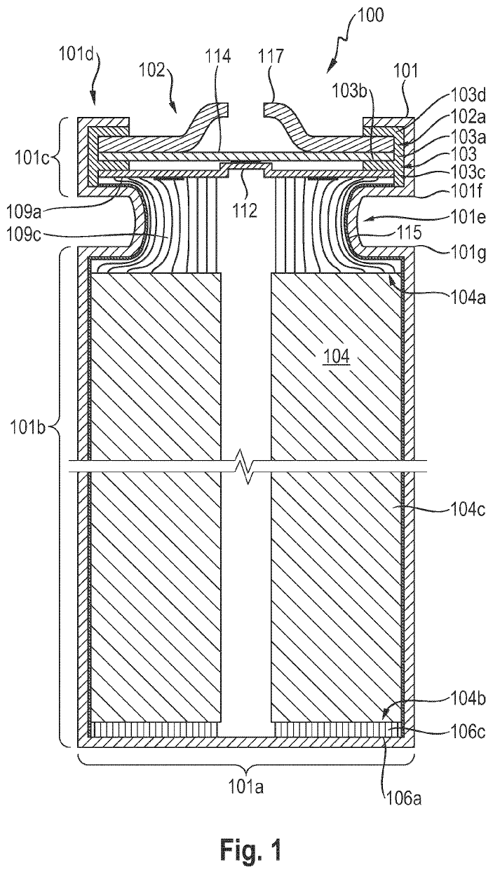

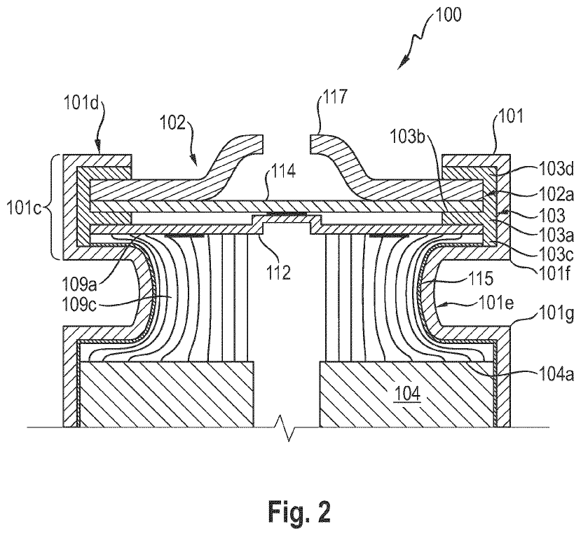

FIG. 1 and FIG. 2 show an energy storage cell 100 with an airtight and liquid-tight housing comprising a metallic housing cup 101 with a terminal circular opening and a lid assembly 102 with a circular edge 102a which closes the circular opening.

The lid assembly 102 further comprises an annular seal 103 made of an electrically insulating material, which surrounds its circular edge 102a and which electrically insulates the housing cup 101 and the metallic components of the lid assembly 102 from each other.

The housing cup 101 comprises, in axial sequence, a bottom 101a, a central section 101b and a closure section 101c, wherein the central section 101b is formed as a cylinder. In the central section 101b, the winding shell 104c of the electrode-separator assembly 104, which is formed as a winding, is in contact with the inside of the housing cup 101. In the closure section 101c, the annular seal 103 is in press contact with the lid assembly 102 and the inside of the housing cup 101. In the closure section 101c, the housing cup 101 has an opening edge 101d defining the circular opening, which is bent radially inwards over the edge 102a of the lid assembly 102 enclosed by the seal 103 and which positively fixes the lid assembly 102 including the seal 103 in the circular opening of the housing cup 101. The central section 101c and the closure section 101d are separated from each other by a radial indentation 101e, which circumferentially surrounds the outside of the housing cup 101.

The lid assembly 102 of the present example comprises, from the inside to the outside, a disk-shaped contact element 112, a circular metallic membrane 114, which bulges or bursts outwards from a defined overpressure inside the housing, and a pole cap 117. The contact element 112 is welded to the membrane 114, which in turn is welded to a pole cap 117, which closes the lid assembly 102 to the outside. If the membrane 114 bulges outwards as a result of excess pressure, which can act directly on the membrane 114 via an aperture in the contact element, the electrical contact between the contact element 112 and the membrane 114 or the pole cap 117 breaks off. At very high pressures, the membrane 114 can also burst.

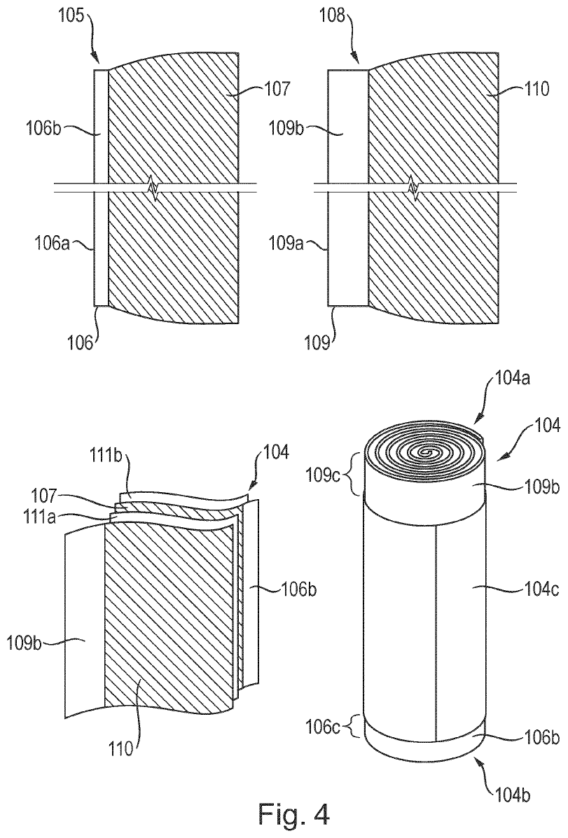

The electrode-separator assembly 104 has a first terminal end face 104a and a second terminal end face 104b with a winding shell 104c located therebetween. Its preferred structure is shown in FIG. 4. It comprises the ribbon-shaped anode 105 with the ribbon-shaped anode current collector 106 and the ribbon-shaped cathode 108 with the ribbon-shaped cathode current collector 109. The anode current collector 106 is preferably a foil made of copper or nickel. The cathode current collector 109 is preferably an aluminum foil. Both the anode current collector 106 and the cathode current collector 109 have a first longitudinal edge 106a, 109a and a second longitudinal edge, a main region 106b, 109b and a free edge strip 106c, 109c. The main regions 106b, 109b are loaded with a layer of electrode material, in the case of the anode with negative electrode material, in the case of the cathode with positive electrode material. The free edge strips 106c, 109c extend along the respective first longitudinal edge and are not loaded with electrode material. Both electrodes are shown individually in an unwound state. Within the wound electrode-separator assembly 104, the anode and the cathode are offset from each other such that the first longitudinal edge 109a of the cathode current collector 109 protrudes from the first terminal end face 104a of the electrode-separator assembly 104. The first longitudinal edge 106a of the anode current collector 106 protrudes from the second terminal end face 104b of the electrode-separator assembly 104. This can be clearly seen in the illustration at the bottom right. The offset arrangement can be seen in the illustration at bottom left. The two ribbon-shaped separators 111a and 111b, which separate the electrodes 105 and 108 from each other in the winding, are also shown there. The winding shell 104c is usually formed by a plastic film.

Returning to FIG. 1 and FIG. 2: Here, the free edge strip 109c is welded to the contact element 112 via the first longitudinal edge 109a of the cathode current collector 109 and is preferably in direct contact with the contact element 112 over its entire length. The contact element covers the first terminal end face 104a of the electrode-separator assembly 104 and lies flat on the first longitudinal edge 109a of the cathode current collector 109. The first longitudinal edge 106a of the anode current collector 106, on the other hand, is welded directly to the bottom 101a of the housing and is preferably in direct contact with the bottom 101a over its entire length.

With this design of the energy storage cell 100, a separate conductor connecting the contact element 112 to a lid assembly can be dispensed with.

The central section 101b and the closure section 101c are separated from each other by a radial indentation 101e, which circumferentially surrounds the housing cup 101 on the outside. The free edge strip 109c protruding from the first terminal end face 104a is wider than the distance d between the central section 101b and the closure section 101c, so that the edge strip 109c bridges the distance d and is in direct contact with the contact element 112. The distance d is defined here by the upper edge 101f and the lower edge 101g, which mark the beginning and end of the indentation 101e.

Since the electrode-separator assembly 104, which is formed as a winding, is wider than the available space in the region of the indentation 101e, the free edge strip 109c of the cathode current collector 109 is pressed inwards towards the center of the housing cup 101 in the region of the indentation 101e. To prevent short circuits from occurring, an electrically insulating material 115 is applied to the inside of the indentation 101e, which electrically insulates the free edge strip 109c of the cathode current collector 109 from the electrical potential of the housing cup 101.

The energy storage cell 100 typically has a height in a range from 60 mm to 120 mm, and its diameter is preferably in a range from 20 mm to 50 mm. The housing cup 101 usually has a wall thickness in a range from 0.1 mm to 0.3 mm in the central section 101b.

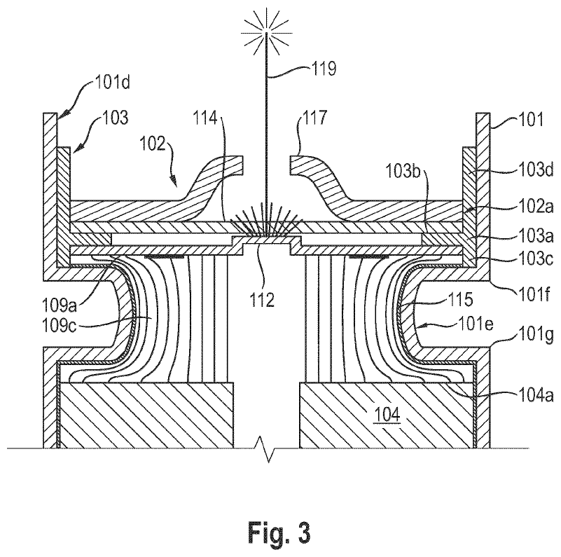

The energy storage cell 100 shown in FIG. 3 differs from those in FIGS. 1 and 2 only in that a laser beam 119 is shown, which is directed through an opening 117a in the pole cap 117 in order to form a weld between the contact element 112 and the membrane 114.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. : An energy storage cell, comprising:
an electrode-separator assembly comprising a ribbon-shaped anode, a ribbon-shaped cathode, and a separator with the sequence anode/separator/cathode, the anode comprising a ribbon-shaped anode current collector with a first longitudinal edge and a second longitudinal edge parallel thereto, the ribbon-shaped anode current collector comprising a main region loaded with a layer of a negative electrode material and a free edge strip extending along the first longitudinal edge and being not loaded with the negative electrode material, the cathode comprising a ribbon-shaped cathode current collector with a first longitudinal edge and a second longitudinal edge parallel thereto, the ribbon-shaped cathode current collector comprising a main region loaded with a layer of a positive electrode material and a free edge strip extending along the first longitudinal edge and being not loaded with the positive electrode material, the anode and the cathode being formed and/or arranged within the electrode-separator assembly, which is formed as a cylindrical winding with a first terminal end face, a second terminal end face, and a winding shell between the first and second terminal end faces, such that the free edge strip of the cathode current collector or the free edge strip of the anode current collector protrudes from the first terminal end face; and
a housing closed in an airtight and liquid-tight manner and enclosing an interior space in which the electrode-separator assembly is arranged, the housing comprising a metallic housing cup with a terminal circular opening and a lid assembly with a circular edge that closes the circular opening,
wherein the lid assembly comprises an annular seal of an electrically insulating material surrounding its circular edge, a metallic contact element, a metallic membrane electrically coupled to the contact element and which is configured to bulge or burst outwards from a defined excess pressure inside the housing, and a metallic pole cap electrically coupled to the metallic membrane,
wherein the housing cup comprises, in axial sequence, a bottom, a central section and a closure section, wherein the central section is formed as a cylinder and in the central section the winding shell of the electrode-separator assembly formed as a winding is in contact with the inside of the housing cup, and wherein, in the closure section, the annular seal is in press contact with the lid assembly and the inside of the housing cup, and
wherein the free edge strip protruding from the first terminal end face is welded to the contact element of the lid assembly.

2. The energy storage cell of claim 1, wherein at least one of:
the ribbon-shaped electrodes are formed and/or arranged within the electrode-separator assembly such that one of the free edge strips of the anode current collector and cathode current collector protrudes from the first terminal end face and the other of the free edge strips protrudes from the second terminal end face of the electrode-separator assembly; and/or
the other of the free edge strips protruding from the second terminal end face of the electrode-separator assembly is electrically coupled to the bottom of the housing cup.

3. The energy storage cell according to claim 1, wherein at least one of:
the membrane is in direct contact with the contact element and is connected to it by welding;
the membrane has a circular shape and a circular edge;
the contact element has a circular shape and a circular edge;
the contact element is welded to the center of the membrane;
the contact element and the membrane have approximately the same diameter; and/or
the membrane and the contact element are in electrical contact with each other exclusively via a welding area in the center of the membrane.

4. The energy storage cell according to claim 1, wherein at least one of:
the annular seal encloses the circular edge of the contact element;
the annular seal encloses the circular edge of the membrane; and/or
the annular seal separates the circular edge of the membrane from the circular edge of the contact element.

5. The energy storage cell according to claim 1, wherein at least one of:
the central section and the closure section are separated from each other by a radial indentation that circumferentially surrounds the outside of the housing cup.
the free edge strip protruding from the first terminal end face is wider than a distance d between the central section and the closure section, such that the edge strip bridges the distance d and is in direct contact with the contact element; and/or
the distance d is defined by an upper edge and a lower edge of the indentation of the housing cup.

6. The energy storage cell of claim 5, wherein at least one of:
the free edge strip protruding from the first terminal end face of the electrode-separator assembly is pressed inwards towards the center of the housing cup in the region of the indentation of the housing cup; and/or
in the region of the indentation, an electrically insulating material is arranged between the inside of the housing cup and the free edge strip protruding from the first terminal end face of the electrode-separator assembly, which electrically insulates the free edge strip from the electrical potential of the housing cup.

7. The energy storage cell according to claim 1, wherein at least one of:
the housing cup has an identical maximum outer diameter in the central section and the closure section; and/or
in the region of the indentation, the outer diameter of the housing cup is reduced by 4 to 20 times the wall thickness of the housing cup in this region.

8. The energy storage cell according to claim 1, wherein at least one of:
the longitudinal edge along which the free edge strip, which protrudes from the first terminal end face of the electrode-separator assembly, extends, forms a surface on which the contact element lies flat or into which the contact element is pressed;
the contact element is dimensioned such that it covers at least 40 of the first terminal end face;
the contact element is a disk or a polygonal plate;
the contact element has at least one aperture;
the contact element has a preferably uniform thickness in a range from 50 μm to 600 μm;
the contact element has two opposite flat sides and extends essentially in only one dimension;
the contact element has at least one bead which appears on one flat side of the contact element as an elongate depression and on the opposite flat side as an elongate elevation, the contact element being pressed into the surface formed by the longitudinal edge with the flat side which bears the elongate elevation; and/or
the contact element is welded to the longitudinal edge of the respective current collector in the region of the bead.

9. The energy storage cell according to claim 1,
wherein one or more openings is/are formed in the center and/or at the edge of the pole cap.

10. A method of manufacturing an energy storage cell having the features of claim 1, the method comprising:
providing the housing cup having the circular opening and the electrode-separator assembly having the first end face and the second end face;
inserting the electrode-separator assembly, second end face first, through the circular opening of the housing cup into the housing cup;
arranging the metallic contact element on the first end face and fixing the metallic contact element in place by welding before or after inserting the electrode-separator assembly into the housing cup;
placing the membrane and the pole cap on the contact element to form the lid assembly; and
forming a weld between the membrane and the contact element.
